(19) United States
(12) Patent Application Publication
(10) Pub. No.: US 2005/0164059 A1
(43) Pub. Date: Jul. 28, 2005

(54) Local vapor fuel cell

(76) Inventors: Laixia Yang, Fargo, ND (US); Wen C. Huang, Fargo, ND (US)

Correspondence Address: Wen C Huang, 2902, 28 AVE, S.W., FARGO, ND, 58103, US

(21) Appl. No.: 10/762,626

(22) Filed: Jan. 23, 2004

(51) Int. Cl. H01M 8/04

(52) U.S. Cl. 429/26; 429/34

(57) ABSTRACT

A local vapor fuel cell, comprising (A) an anode receiving a liquid fuel from a liquid fuel source substantially through diffusion; (B) an electrolyte plate having a first surface adjacent to the anode; and (C) a cathode adjacent to a second surface of the electrolyte plate and opposite to the anode. The anode is provided with a heating environment to at least partially vaporize the liquid fuel inside the anode and the anode further comprises a catalyst phase to ionize the fuel in a vapor or vapor-liquid mixture form to produce protons. The electro-catalytic reaction at the anode is more efficient with a vapor phase or vapor-liquid mixture than with liquid fuel alone. The invented fuel cell is compact in size and light in weight and, hence, is particularly useful for powering small microelectronic devices such as a notebook computer, a personal digital assistant, a mobile phone, and a digital camera.

### FIELD OF THE INVENTION

This invention relates to a fuel cell operating on a hydrogen-rich organic fuel that is initially in a liquid form directly fed via diffusion into the anode; but the fuel turns into a vapor form when it comes in contact with the catalyst phase in the anode. The diffusion process is preferably driven by a capillarity force without using a liquid delivery pump. The invention specifically relates to a local vapor fuel cell (LVFC) such as a methanol vapor fuel cell (MVFC) or ethanol vapor fuel cell (EVFC).

### BACKGROUND OF THE INVENTION

A fuel cell is a device which converts the chemical energy into electricity. A fuel cell differs from a battery in that the fuel and oxidant of a fuel cell are supplied from sources that are external to the cell, which can generate power as long as the fuel and oxidant are supplied. A particularly useful fuel cell for powering portable electronic devices is a direct methanol fuel cell (DMFC) in which the fuel is a liquid methanol/water mixture and the oxidant is air or oxygen. Protons are formed by oxidation of methanol and water at the anode (fuel electrode) and pass through a proton-exchange membrane (or polymer electrolyte membrane, PEM) from the anode to the cathode (oxidant electrode). Electrons produced at the anode in the oxidation reaction flow in the external circuit to the cathode, driven by the difference in electric potential between the anode and cathode and can therefore do useful work.

The electrochemical reactions occurring in a direct methanol fuel cell which contains an acid electrolyte are:
Anode: CH₃OH+H₂O→CO₂+6H⁺+6e⁻ (1)
Cathode: 3/2O₂+6H⁺+6e⁻→3H₂O (2)
Overall: CH₃OH+3/2O₂→CO₂+2 H₂O (3)

The DMFC and other proton-exchange membrane fuel cells (PEMFCs) use a hydrated sheet of a perfluorinated acid-based ionomer membrane as a solid electrolyte. The electrodes each typically containing a catalyst phase (usually a thin catalyst layer) are intimately bonded to each side of the membrane. This membrane is commercially available from either DuPont (under the trade name Nafion®) or from Dow Chemical. Many catalysts to promote methanol oxidation (Reaction 1) have been evaluated. Examples include: (1) noble metals, (2) noble metal alloys, (3) alloys of noble metals with non-noble metals, (4) chemisorbed layers on Pt, (5) platinum with inorganic material, and (6) redox catalysts. Based on literature reports, Pt—Ru appears to be the best methanol-oxidation catalyst in acidic electrolytes.

The methanol/water feed to a DMFC may be in the liquid or vapor phase. If fuel cells using liquid fuel are available in small size, they would be able to power small-sized electronic devices for a long time. However, conventional DMFCs require pumps and blowers to feed liquid fuel to the fuel cell (e.g., S. Surampudi, et al., U.S. Pat. No. 6,248,460, Jun. 19, 2001). The resulting power system is complex in structure and large in size. One way to overcome this problem is to utilize capillary action to feed liquid fuel, without using a liquid delivery pump.

However, a fuel cell of this type still has the following disadvantages: (1) poor performance due to low electrode reactivity and (2) low fuel utilization efficiency due to methanol cross-over from the anode through the electrolyte membrane to the cathode. This problem of methanol crossing over without being reacted is relatively more severe in a fuel cell with a pressurizing pump than in one without a pump.

It is believed that methanol vapor cells that operate at higher temperatures are advantageous in that the step of methanol ionization to produce protons (e.g., Reaction (1)) proceeds more rapidly in these cells (e.g., as suggested in A. A. Kulikovsky, et al. “Two-dimensional simulation of direct methanol fuel cell,” in Journal of the Electrochemical Society, 147 (3) (2000) 953-959). Presumably, a higher temperature results in a higher catalytic electrode activity and the faster reaction leads to a reduction in fuel cross-over. However, in the conventional DMFC of a vapor feed type, methanol (as a liquid fuel) is introduced by a pump into a vaporizer which vaporizes methanol with the resulting methanol vapor then being fed to the fuel cell by a blower. Unconsumed methanol vapor discharged from the outlet of the fuel electrode is recycled to the methanol tank through a condenser. This process needs a complex system (including a pump, a vaporizer, a blower, and a condenser) and, hence, is not suitable for powering small-sized electronic devices.

Tomimatsu, et al. (U.S. Pat. No. 6,447,941, Sep. 10, 2002) disclosed a fuel cell in the form of stacked unit cells each having a power generating section composed of a fuel electrode, an oxidant electrode, and an electrolyte plate held therebetween. The unit cells are placed on top of one another. In this fuel cell, a liquid fuel is introduced into each unit cell by the capillary action and evaporated in each unit cell in a fuel evaporating layer, so that the fuel electrode is supplied with the evaporated fuel. This is a very interesting fuel cell design since it makes use of the two sound approaches: liquid feed by capillary action and vapor state reaction. However, the fuel cell configuration is still too complex since each unit cell contains, among other layers, separate anode, liquid-permeating, and fuel evaporating layers. Too many layers make the fuel cell more tedious to make and more costly.

One object of the present invention is to provide a simpler configuration for a fuel cell that operates primarily on an organic fuel vapor. A specific object of the present invention is to provide a fuel cell that operates on a diffusion-fed methanol/water liquid fuel, which is then vaporized in situ at or near the anode catalyst prior to being ionized to produce protons.

From a systems standpoint, fuel cell operation on liquid methanol-water mixture containing some of the corresponding vapor is more advantageous. Therefore, another object of the present invention is to provide a fuel cell that operates on an organic fuel such as methanol that is at least partially vaporized when in contact with the anode catalyst.

### BRIEF SUMMARY OF THE INVENTION

The present invention provides a light-weight, compact fuel cell that is well-suited to powering portable electronic devices. The invented local vapor fuel cell (LVFC) is composed of one or several unit cells that are physically stacked together and are electrically connected in series to provide a desired voltage level. Each unit cell comprises (A) an anode receiving a liquid fuel from a liquid fuel source substantially through diffusion; (B) an electrolyte plate (or proton exchange membrane, PEM) having a first surface adjacent to the anode; and (C) a cathode adjacent to a second surface of the electrolyte plate and opposite to the anode. The anode is provided with a heating environment to at least partially vaporize the liquid fuel inside the anode to produce fuel vapor near or at the catalyst phase. The catalyst phase ionizes the fuel vapor or the vapor-liquid mixture to produce protons that migrate through the PEM (e.g., a polymer electrolyte membrane) to the cathode side. The catalyst phase preferably forms a thin layer adjacent to the electrolyte plate.

A special feature of the presently invented LVFC is that the fuel (e.g., methanol/water mixture) is supplied initially in a liquid form into the anode primarily via diffusion, preferably under the action of a capillary force. To accomplish this function, the anode may be made to comprise a porous fuel-permeating material being in fluid communication with a liquid fuel source and receiving the liquid fuel therefrom. However, the liquid fuel is vaporized, partially or completely, just before or when it comes in contact with a catalyst. This heated environment allows the fuel vapor or vapor-liquid mixture to react at a higher temperature in a more efficient manner for proton generation. The heating environment may receive the heat generated by the electrochemical reactions occurring at the cathode. Alternatively or additionally, the heating environment may receive the heat from joule heating by passing a current through the anode. This current may flow through a thin wire that is preferably localized in the vicinity of the catalyst phase. The current may be provided intermittently on demand with the assistance of a temperature sensor and a control circuit. Other preferred embodiments of the present invention include several configurations of multiple-cell fuel cell devices with each of these cells exhibiting the aforementioned features.

The LVFC that relies on a heating element to provide additional heat to help locally vaporize the liquid fuel at the anode catalyst phase is hereinafter referred to as an extrinsically controlled LVFC or actively controlled LVFC. The FVFC that relies primarily on the internally generated heat due to electrode reactions is referred to as an intrinsically controlled LVFC or passively controlled LVFC. The advantages of such an extrinsically controlled LVFC includes:
(1) The amount of electrical power needed to generate the local joule heat represents only a very small fraction of the total amount of power that a fuel cell can provide. The resulting improvement in the power output considerably more than compensates for the power loss that is required to locally vaporize the fuel.
(2) Since the heat is generated locally to vaporize the liquid fuel near the anode, there is very little heat loss to the outside environment. By contrast, the current direct methanol fuel cell of a direct vapor feed type requires a vaporizer and a blower to deliver the vaporized fuel from the vaporizer to the fuel cell body through a pipe. This procedure is prone to heat energy loss. Besides, the combined vaporizer-blower-pipe makes the fuel cell bulky and heavy.
(3) The vaporous fuel at a higher temperature means a faster and more efficient catalytic reaction at the anode catalyst site. This reaction condition promotes essentially full conversion of the fuel into the desired electrons and protons, thereby minimizing methanol crossover from the anode to the cathode side through the electrolyte. A reduced methanol crossover implies not only a higher electro-oxidation of methanol-water fuel at the anode, but also less methanol “poisoning” of the cathode catalyst which allows better contacts between oxygen and the cathode catalysts.
(4) The liquid fuel feeding via capillarity pressure-driven diffusion of liquid fuel through the anode makes it possible to have a highly compact fuel cell assembly due to the fact that no liquid fuel pump or vapor fuel blower is needed in the LVFC.

The above extrinsically controlled LVFC, in practice, needs a temperature sensor, a heating element, and a simple temperature-controlling circuit. The intrinsically controlled LVFC has the following added advantage:
(5) The fuel cell geometry (size and shape) and material compositions involved can be selected in such a manner that the methanol-water fuel is in a vaporous state locally at the anode catalyst phase, but in a liquid state at other locations of the anode side. The needed heat comes primarily from the inherent electrode reactions. This feature will allow an intrinsically controlled LVFC to enjoy the same advantages (3) and (4) cited above for the extrinsically controlled LVFC, but without having to implement a temperature sensor, heater, and temperature controlling circuit.

### BRIEF DESCRIPTION OF THE DRAWINGS

FIG. 1 A cross sectional view showing the components of a prior-art fuel cell that operates on fuel vapor.

FIG. 2 A cross sectional view showing the structure of the components of a fuel cell containing anode catalysts that operate locally on a fuel vapor or vapor-liquid mixture.

FIG. 3 A perspective view showing the components of the fuel cell of the present invention.

FIG. 4 A cross sectional view showing the structure of the components of a fuel cell wherein the anode contains a heating element to help vaporize the fuel.

FIG. 5 The voltage-current responses of two fuel cells.

### DETAILED DESCRIPTION OF THE INVENTION

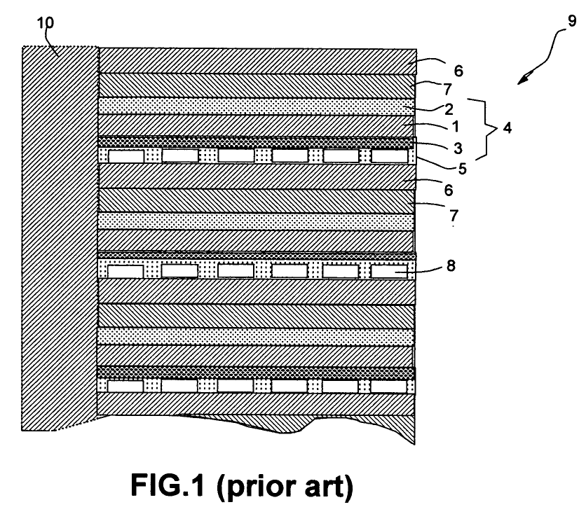

In order to best illustrate the features and advantages of the presently invented fuel cells, relevant prior-art fuel cells will be briefly discussed first. An example of prior-art fuel cells that operate on organic fuel vapor is presented in FIG. 1 (Tomimatsu, et al., U.S. Pat. No. 6,447,941, Sep. 10, 2002). This cross sectional view of the structure includes an electrolyte plate 1, which is held between a fuel electrode (anode) 2 and an oxidant electrode (cathode) 3. The electrolyte plate 1, the anode 2, and the cathode 3 constitute the power generating section 4. The anode 2 and the cathode 3 are made of an electrically conductive porous material so that they allow the passage of fuel and oxidant gas as well as electrons.

This prior-art fuel cell contains a fuel-permeating layer 6 and a separate fuel evaporating layer 7. Layer 6 introduces liquid fuel into the fuel cell by the capillary action. The fuel evaporating layer 7 is interposed between the anode 2 and the liquid fuel-permeating layer 6.

Layer 7 evaporates the liquid fuel which is introduced into the fuel cell and feeds the fuel in the form of vapor to the anode 2, which is another separate layer. Layers 2, 1, and 3 together form a 26 power-generating section 4. Layers 3, 1, 2, 7, 6 together constitute a “unit cell”. Several of these unit cells are placed on top of another consecutively, with a separator 5 interposed between them, so that they constitute a stack 9 which is the fuel cell proper. The grooves 8 through which the oxidant gas is supplied are formed continuously in that surface of the separator 5 which is in contact with the cathode 3.

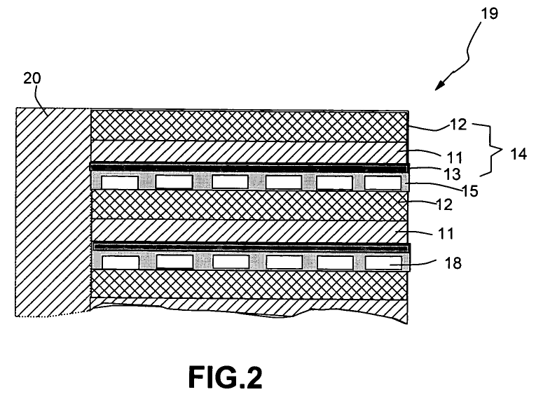

It is clear that this prior-art fuel cell, although much simplified over other existing fuel cells, still has a relatively complex configuration and has too many layers. By contrast, we have 6 integrated the fuel-permeating layer, the fuel evaporating layer, and the anode layer into just one anode layer 12 (FIG. 2). Preferably, the catalyst phase in the anode layer 12 is arranged to be in a close proximity to or in an intimate contact with the electrolyte layer 11. The catalyst phase may be essentially a thin layer (of a nanometer thickness) at the edge of the anode layer 12 facing the electrolyte layer 11. In such an arrangement, the reaction heat generated by the inherent electro-chemical reactions can easily reach the catalyst phase to help vaporize the fuel that has permeated to the vicinity of the catalyst. It is not necessary to vaporize all the liquid fuel that has permeated into the anode layer, only the portion close to or in contact with the catalyst (hence, the name “local vapor fuel cell”).

It may be noted that, in the aforementioned prior-art fuel cell (FIG. 1), the fuel permeating layer 6 is isolated or separated from the reaction electrodes in such a distance that it cannot effectively receive the reaction heat generated by the cell reactions. The prior-art inventors also failed to recognize that a fuel vapor-liquid mixture works nearly as well as a pure vapor in the anode reaction for proton production, which we surprisingly found to be the case. It is desirable to select the electrolyte layer thickness and other reaction conditions such that the catalyst phase is heated by the reaction heat to a temperature significantly higher than 64° C. (the boiling point of methanol) in the case of using methanol/water mixture as the liquid fuel. The local reaction temperature at the anode catalyst for the methanol fuel cell is preferably in the range of 80-150° C., but most preferably in the range of 95-130° C. Although a higher temperature is generally preferred for a higher efficiency, an excessively high local temperature can spill over to other portions of the anode, making it more difficult to maintain the fuel in other portions of the anode (than the catalyst layer area) in a liquid state.

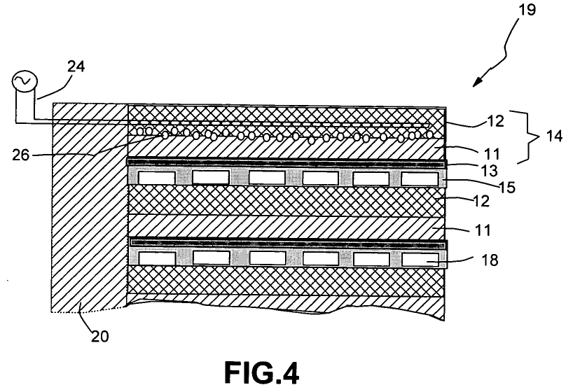

Alternatively, one may choose to introduce a thin metal wire or conductive fiber (e.g., 24 in FIG. 4) into the catalyst side of the anode layer to help vaporize the liquid fuel in the vicinity of the catalyst phase (26 in FIG. 4). A small amount of current may be allowed to flow through this wire or fiber to produce joule heat. A minute temperature sensor element (e.g., a thin thermocouple wire) may be placed inside the anode to monitor the catalyst phase temperature. Temperature monitoring and control devices or circuits are well-known in the art. Such a combined heating element-sensor arrangement is advantageous in that additional heat may be supplied to vaporize more fuel on demand (e.g., when needed, more current may be supplied to the external load by vaporing the fuel at a faster rate and allowing the reactions to proceed at a higher temperature). With such an added adaptability, the fuel cell essentially becomes a smart, actively controlled power source. A simple logic circuit may be added as a part of the fuel cell voltage regulator or control circuit that is normally installed in a fuel cell for electronic device applications.

In one special fuel cell design of Tomimatsu, et al., there is a combined fuel permeating-evaporating member, which has a fuel permeating portion and a fuel evaporating portion. However, this combined layer has to be made to contain specially machined holes and are complex in configuration. This requirement makes this layer and the whole fuel cell assembly more difficult and costly to produce despite the notion that this combination makes it possible to decrease the thickness of the member, as compared with the case where each of these fuel permeating member and the fuel evaporating member are formed of individual members separately.

As a means to feed liquid fuel to the anode layer 12 from a fuel source, there is formed a liquid fuel passage 20 along at least one side of the stack 19 (FIG. 2). Upon introduction into the liquid fuel passage 20, the liquid fuel is fed to the fuel permeating material of the anode layer 12 by the capillary action from the side of the stack 19. In order to supply liquid fuel to the fuel permeating material by the capillary action, the fuel cell is constructed such that the liquid fuel which has been introduced into the liquid fuel passage 20 comes in direct contact with the end surface of the anode layer 12.

The separator 15 (when existing) and the anode layer 12 (including the fuel permeating material therein) are each made of an electrically conductive material so that they function as a current collector to transmit electrons generated in the fuel cell. The fuel cell in this example (FIG. 2) has the separator 15 which functions also as a channel to permit the oxidant gas to flow therethrough into the cathode. The advantages of using the multi-purpose separator 15 include a size reduction and reduction in the number of parts used.

The liquid fuel passage 20 may be constructed such that the liquid fuel is introduced from a fuel source (not shown) into the fuel permeating material of the anode layer 12 by the capillary action. One way to supply liquid fuel from the fuel source to the liquid fuel passage 20 is to permit the liquid fuel to drop spontaneously by gravity and to enter the liquid fuel passage 20. This gravitational method offers the advantage of assuring the introduction of the liquid fuel into the liquid fuel passage 20, although it requires that the fuel source be positioned above the top of the stack 19. Another method is to introduce the liquid fuel from the liquid fuel source by the capillary action of the liquid fuel passage 20. This method does not require that the joint between the liquid fuel source and the liquid fuel passage 20 (or the fuel entrance of the liquid fuel passage 20) be arranged above the top of the stack 19. When combined with the gravitational method, this method offers the advantage of being free to install the fuel source at any place or orientation. The liquid fuel passage 20 may be formed on one side or both sides of the stack 19.

The fuel source described above may be made detachable from the fuel cell proper, so that the fuel cell can be run for a prolonged period of time by intermittently replenishing the fuel source. The feeding of the liquid fuel from the fuel source to the liquid fuel passage 20 may be accomplished by gravity or by pressure in the source. An alternative feeding method is to extract the liquid fuel by the capillary action of the liquid fuel passage 20.

The structure of the fuel permeating material in the anode layer is not specifically restricted as far as it permits the liquid fuel to permeate through it by the capillary action. It may be made of a porous material, cotton, non-woven fabric, highly porous paper, or woven cloth of fibers. The fuel permeating material draws liquid fuel into it by the capillary action. For the effective use of the capillary action, the fuel-permeating porous material should be formed such that its pores are interconnected and its pores have an adequate pore diameter. The porous material may have any pore diameter which is not specifically restricted, as long as it permits the liquid fuel to be drawn into the liquid fuel passage 20. However, the pore diameter is preferably 0.01 to 150 μm in view of the capillary action of the liquid fuel passage 20. Furthermore, the pore volume as an index of pore continuity should preferably be 20 to 90% of the porous material. With a pore diameter smaller than 0.01 μm, it becomes difficult for liquid fuel to diffuse through the pores; this could be understood from the well-known Darcy's Law that describes the diffusion behavior of a liquid through a porous medium. With a pore diameter larger than 150 μm the porous material is poor in its capillary action. With a pore volume less than 20%, the porous material has closed pores in a higher proportion and hence is poor in its capillary action. With a pore volume fraction greater than 90%, the porous material has a higher proportion of continuous pores but is poor in strength and present difficulties in fabrication. Practically, the pore diameter should preferably be 0.5 to 100 μm and the pore volume fraction should preferably be 30 to 75%.

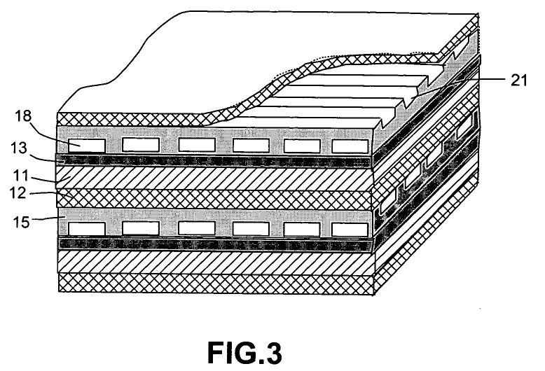

Liquid fuel feeding grooves 21 may be formed in the surface of the separator 15 (serving also as the channel) in contact with the fuel permeating material of the anode layer 12, as shown in FIG. 3. The capillary action of these grooves may be used to draw liquid fuel into the fuel permeating material also through the capillary action. In this case, the liquid fuel passage 20 should be formed such that the open ends of the liquid fuel feeding grooves 21 come into direct contact with the liquid fuel passage 20 (indicated in FIG. 2, but not FIG. 3). Alternatively, it is possible to use the capillary action of the liquid fuel feeding grooves 21 in combination with the capillary action of the porous material constituting the fuel permeating material of the anode layer 12.

It may be noted that the liquid fuel feeding grooves 21 are not specifically restricted in configuration as long as they are capable of producing an adequate capillary action. However, they should be formed such that their capillary action is smaller than that of the fuel permeating material of the anode layer. Otherwise, the liquid fuel will not be fed from the liquid fuel passage 20 to the fuel permeating material. The liquid fuel feeding grooves 21 are intended to extract liquid fuel from the liquid fuel passage 20 by their capillary action. Therefore, they should be formed such that their capillary action is greater than that of the liquid fuel passage 20 in the case where the liquid fuel is introduced from the fuel source into the liquid fuel passage 20 by its capillary action. Thus, the configuration of the liquid fuel feeding grooves 21 should be formed in accordance with the configurations of the porous material constituting the fuel permeating material of the anode layer 12 and the liquid fuel passage 20.

The separator 15 serving also as the channel is provided with the liquid fuel feeding grooves 21 extending in the horizontal direction, as mentioned above. This construction permits the liquid fuel to be fed from the entire surface of the end of the anode 12 to the fuel permeating material inside the anode layer and also permits the liquid fuel to be fed in the lateral direction across the anode layer through the grooves 21. This makes it possible to feed liquid fuel more smoothly from the liquid fuel passage 20 to the fuel permeating material.

In the aforementioned example, the separator 15 serving also as the channel is provided with both the oxidant gas feeding grooves 18 and the liquid fuel feeding grooves 21. Alternatively, the anode layer 12 and the cathode 13 may be individually provided with channels. In this case, one set of channels should be separated from another set of channels by an electrically conductive plate to block the passage of gas, or the holes on the surface of at least one set of channels should be closed, so that the liquid fuel is separated from the oxidant gas. In order to decrease the number of parts used and to reduce the size of the fuel cell, it is desirable to use the separator containing both types of channels.

The examples described above are directed to a fuel cell which has the stacks 19 (each composed of a power generating section 14) which are placed on top of the other, with each stack separated by the separator 15. However, the fuel cell of the present invention does not necessarily need the separator channels. In this case, the oxidant gas feeding grooves 18 may be continuous ones formed in the surface in contact with the cathode.

In another embodiment of the present invention, the fuel cell may have a liquid fuel-holding portion positioned on the anode (in contact with one of the two primary or larger-area surfaces of the anode, rather than on one end or both ends of the anode). In this case, the fuel cell comprises (a) a cathode, (b) an electrolyte plate disposed on the cathode, (c) an anode disposed on the electrolyte plate and configured to be supplied with a liquid fuel, and (d) a liquid fuel-holding portion disposed on the anode. The anode is provided with a heating environment to at least partially vaporize the liquid fuel inside the anode and the anode further comprises a catalyst phase to ionize the fuel in a vapor or vapor-liquid mixture form to produce protons. Other features and operating methods of this fuel cell are similar to those discussed earlier in other embodiments.

### EXAMPLE 1

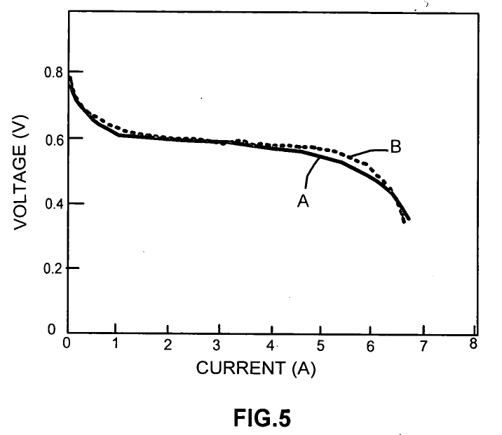

A fuel cell was prepared as follows: Graphite flakes were subjected to a ball-milling treatment to obtain fine particles of several microns in size. These fine particles were mixed with a phenolic resin to obtain a slurry mixture. Chopped carbon fibers were then mixed with the slurry mixture to prepare a composite, which was then molded at a temperature of 250° C. for one hour with a hot press and then partially carbonized first at 350° C. and then at 600° C. for approximately two hours. These treatments lead to the formation of a thin, highly porous carbon structure having an average pore diameter of 60 μm and a porosity of approximately 65%. A sheet of this carbon composite structure was coated on one side with a Pt—Ru catalyst to give an anode of 32 mm×32 mm in dimensions. A carbon cloth was coated with a platinum black catalyst to give a cathode also of 32 mm×32 mm. A polymer electrolyte membrane, poly(perfluorosulfonic acid) ionomer, was held between the anode and the cathode, with the catalyst layers in contact with the electrolyte membrane. The assembly was joined together by hot-pressing at 120° C. for 5 minutes under a pressure of 100 kg/cm², to give a power generating section. The resulting assembly was held between a cathode holder and an anode holder, the former having oxidant gas feeding grooves each having a depth of 2 mm and a width of 1 mm. The obtained unit cell has a reaction area of 10 cm². The fuel cell was supplied with a methanol/water mixture at an 1:1 molar ratio as a liquid fuel. The liquid fuel was introduced by the capillary action through the side of the anode. The air at 1 atm as an oxidant gas was fed into the gas channels at a flow rate of 100 mL/min so that the fuel cell generated electricity at 76° C. This fuel cell gave a current-voltage characteristic as shown in Curve A of FIG. 5.

### COMPARATIVE EXAMPLE 1

A fuel cell of the prior-art type was prepared as follows. An assembly for the power generating section was prepared in the same way as in Example 1. However, the power generating section was further combined with a fuel evaporating layer and a fuel permeating layer as shown in FIG. 1. The fuel evaporating layer is a porous carbon plate having an average pore diameter of 100μ and a porosity of 70%. The fuel permeating layer is a porous carbon plate having an average pore diameter of 5 μm and a porosity of 40%. The liquid fuel cell thus obtained was supplied with a methanol-water mixture mixed at a 1:1 molar ratio as a liquid fuel. The liquid fuel was introduced by the capillary action through the side of the anode. The air at 1 atm as an oxidant gas was fed into the gas channels at a flow rate of 100 mL/min so that the fuel cell generated electricity at 79° C. (measured at the catalyst/electrolyte interface). This fuel cell gave a current-voltage characteristic as indicated in Curve B of FIG. 5.

The two curves shown in FIG. 5 demonstrate that the fuel cells in both examples produce a stable output voltage until the current reaches about 5 amps. This implies that it may not be necessary to have separate liquid fuel-permeating and fuel-vaporizing layers (that would make the fuel cell more bulky, heavy and expensive). It appears that as long as the catalyst phase works primarily with a fuel vapor, the fuel cell is capable of achieving a high reactivity and low methanol cross-over (from the anode to the cathode side).

### EXAMPLE 2

A series of fuel cells were prepared and operated in the same way as in Example 1, with the exception that a thin copper wire was introduced into and out of the anode at a location very close to the polymer electrolyte layer (and, hence, close to the catalyst layer). A desired amount of current was fed into this zone to vary the fuel temperature between approximately 64° C. (the boiling point of methanol) and 130° C. (30° above 100° C., the boiling point of water) while the exterior temperature was maintained at a relatively low level by blowing a cool air to the fuel cell while in operation. It was found that, in general, the higher the reaction temperature, the more stable the voltage was. A higher local temperature near the catalyst phase implies not only a higher vapor content, but also a higher electrolytic reaction rate at the anode (Reaction 1). Both factors are in favor of a more stable voltage response as a function of current by way of an increased reactivity (faster and more efficient fuel conversion) and reduced chance of fuel cross-over.

It may be noted that, although the examples given herein are based on the methanol/water mixture as the liquid fuel, the presently invented fuel cell is not limited to this particular type of fuel. The present fuel cell can operates on any organic fuel that has a high hydrogen content (e.g., ethanol and hexane) and can be fed in a liquid form into the anode through diffusion and then vaporized locally at the catalyst phase. For instance, the ethanol/water mixture can be used in the fuel cell when the catalyst zone is heated to a temperature above 78° C., up to approximately up to 130° C. with poly(perfluorosulfonic acid) being the PEM used. This upper temperature appears to be limited by the working temperature of the polymer electrolyte. With a more thermally stable polymer electrolyte membrane, such as sulfonated polyimide, the vapor fuel temperature can be pushed even higher. A temperature up to 150° C. (approximately 50 degrees above the boiling temperature of water) was found to work well.

Hence, another embodiment of the present invention is a fuel cell which comprises (A) an anode comprising a catalyst phase and receiving a liquid fuel from a liquid fuel source (with the liquid fuel having a minimum boiling point T_{b}(min) and a maximum boiling point T_{b}(max)); (B) an ion exchange electrolyte having a first surface adjacent to the anode; and (C) a cathode adjacent to a second surface of the electrolyte. In this fuel cell, the anode is provided with a heating environment inside the anode to ensure that the catalyst phase operates at a temperature between T_{b}(min) and approximately [T_{b}(max)+50 degrees C.] to ionize the fuel to produce ions that move across the ion exchange electrolyte.

It is known that water has a boiling point of 100° C., methanol has a boiling point of approximately 64°, and ethanol has a boiling point of approximately 78.5° C. For a fuel cell fed with a mixture of water and methanol, the catalyst phase operates on methanol in a vaporous state and water in substantially liquid state if the local temperature is in the range of 64° C. and 100° C. Both methanol and water will be substantially vaporized if the catalyst temperature exceeds 100° C. It is particularly advantageous to allow the catalyst phase to operate at a local temperature of slightly higher than 100° C., but preferably not higher than 130° C. with an ion exchange electrolyte comprising poly(perfluorosulfonic acid) as the primary ion-conducting medium. For the ethanol/water mixture, the catalyst operating temperature is in the range of 78° C. and 150° C., but preferably in the range of 100° C. and 130° C. For a three-component mixture (water+methanol+ethanol), the catalyst operating temperature is in the range of 64° C. and 150° C., preferably in the range of 78° C. and 130° C., but most preferably between 100° C. and 130° C.

1. A fuel cell, comprising:
(A) an anode comprising a catalyst phase and receiving a liquid fuel from a liquid fuel source substantially through diffusion;
(B) an electrolyte component having a first surface adjacent to said anode; and
(C) a cathode adjacent to a second surface of said electrolyte component; wherein said anode is provided with a heating environment to at least partially vaporize said liquid fuel inside said anode near said catalyst phase which operates to ionize said fuel in a vapor or vapor-liquid mixture form to produce protons and electrons.

2. The fuel cell according to claim 1, wherein said catalyst phase forms a thin layer adjacent to said electrolyte component.

3. The fuel cell according to claim 1, wherein said heating environment receives heat resulting from the inherent electrochemical reactions of the fuel cell.

4. The fuel cell according to claim 1, wherein said heating environment receives heat from joule heating by passing a current through said anode at or near said anode catalyst phase.

5. The fuel cell according to claim 1, wherein said anode comprises a porous fuel-permeating material in fluid communication with said liquid fuel source.

6. The fuel cell according to claim 5, wherein said fuel-permeating material exhibits a capillary phenomenon, and is configured to receive said liquid fuel from said source by a capillary force.

7. The fuel cell according to claim 5, wherein the porous fuel-permeating material is selected from the group consisting of porous materials, cottons, papers, non-woven fabrics, and woven fabrics which produce a capillary action.

8. The fuel cell according to claim 7, wherein the porous material is one which has a pore volume of 20 to 90% and a pore diameter of 0.01 to 150 μm.

9. A fuel cell, comprising:
(A) a first power generating section and a second power generating section, which are placed on top of the other with a separator interposed therebetween;
said first power generating section being composed of a first anode, a first electrolyte plate, and a first cathode, which are placed sequentially one over another;
said second power generating section being composed of a second anode, a second electrolyte plate, and a second cathode, which are placed sequentially one over another; and
(B) a liquid fuel passage formed adjacent to both of said first and second power generating sections and configured to supply said first and second anodes with said liquid fuel through said liquid fuel passage;
wherein said first anode and said second anode are each provided with a heating environment to at least partially vaporize said liquid fuel inside said anodes and said anodes each further comprises a catalyst phase to ionize said fuel in a vapor or vapor-liquid mixture form to produce protons and electrons.

10. The fuel cell according to claim 9, wherein said first anode and said second anode each comprises a fuel-permeating material in flow communication with said liquid fuel passage.

11. The fuel cell according to claim 9, wherein the separator has oxidant gas feeding channels in its surface.

12. The fuel cell according to claim 10, wherein the separator has liquid fuel feeding grooves formed in its surface which is in contact with the fuel permeating material of said first anode.

13. The fuel cell according to claim 10, wherein the fuel permeating material of said first anode has a capillary action greater than that of the liquid fuel passage.

14. The fuel cell according to claim 9, wherein said catalyst phase forms a thin layer adjacent to said electrolyte plate.

15. The fuel cell according to claim 9, wherein said heating environment receives heat resulting from the intrinsic electrochemical reactions of the fuel cell.

16. The fuel cell according to claim 9, wherein said heating environment receives heat from joule heating by passing a current through said first anode and/or said second anode.

17. The fuel cell according to claim 10, wherein the fuel-permeating material is selected from the group consisting of porous materials, cotton, papers, non-woven fabrics, and woven fabrics which produce a capillary action.

18. A fuel cell, comprising:
(A) a cathode;
(B) an electrolyte plate disposed on said cathode;
(C) an anode disposed on said electrolyte plate and configured to be supplied with a liquid fuel; and
(D) a liquid fuel holding portion disposed on said anode to supply liquid fuel thereto;
wherein said anode is provided with a heating environment to at least partially vaporize said liquid fuel inside said anode and said anode further comprises a catalyst phase to ionize said fuel in a vapor or vapor-liquid mixture form to produce protons and electrons.

19. The fuel cell according to claim 18, wherein said catalyst phase forms a thin layer adjacent to said electrolyte plate.

20. The fuel cell according to claim 18, wherein said heating environment receives heat resulting from the electrochemical reactions of the fuel cell.

21. The fuel cell according to claim 18, wherein said heating environment receives heat from joule heating by passing a current through said anode.

22. The fuel cell according to claim 18, wherein said anode comprises a porous fuel-permeating material in fluid communication with said liquid fuel holding portion.

23. The fuel cell according to claim 22, wherein said fuel-permeating material exhibits a capillary phenomenon, and is configured to receive said liquid fuel from said liquid fuel holding portion by a capillary force.

24. The fuel cell according to claim 22, wherein the porous fuel-permeating material is selected from the group consisting of porous materials, cotton, papers, non-woven fabrics, and woven fabrics which produce a capillary action.

25. The fuel cell according to claim 1, further comprising a temperature sensor to monitor the fuel temperature at or near said catalyst phase.

26. The fuel cell according to claim 25, further comprising a temperature control device to regulate the fuel temperature near or at said catalyst phase.

27. The fuel cell according to claim 9, further comprising a temperature control device to monitor and regulate the fuel temperature at or near the catalyst phase in at least one of said first anode and second anode.

28. The fuel cell according to claim 18, further comprising a temperature control device to monitor and regulate the fuel temperature at or near said catalyst phase.

29. A fuel cell, comprising:
(A) an anode comprising a catalyst phase and receiving a liquid fuel from a liquid fuel source, said liquid fuel having a minimum boiling point T_{b}(min) and a maximum boiling point T_{b}(max);
(B) an ion exchange electrolyte having a first surface adjacent to said anode; and
(C) a cathode adjacent to a second surface of said electrolyte;
wherein said anode is provided with a heating environment inside said anode so that said catalyst phase operates at a temperature between T_{b}(min) and T_{b}(max)+50 degrees Centigrade to ionize said fuel to produce ions that move across said ion exchange electrolyte.

30. The fuel cell according to 29, wherein said liquid fuel comprises a mixture of water with a boiling point of 100° C. and an alcohol selected from the group consisting of methanol with a boiling point of approximately 64°, ethanol with a boiling point of approximately 78.5° C., and combinations of both methanol and ethanol.
